(19) United States
(12) Patent Application Publication
(10) Pub. No.: US 2013/0042235 A1
(43) Pub. Date: Feb. 14, 2013

(54) DYNAMIC BOOTSTRAP LITERAL PROCESSING WITHIN A MANAGED RUNTIME ENVIRONMENT

(71) Applicants: Peter W. Burka, Ottawa (CA); Daniel J. Heidinga, Ottawa (CA); Karl M. Taylor, Kanata (CA)

(72) Inventors: Peter W. Burka, Ottawa (CA); Daniel J. Heidinga, Ottawa (CA); Karl M. Taylor, Kanata (CA)

(73) Assignee: INTERNATIONAL BUSINESS MACHINES CORPORATION, Armonk, NY (US)

(21) Appl. No.: 13/207,205

(22) Filed: Aug. 10, 2011

(51) Int. Cl. G06F 9/455

(52) U.S. Cl. 718/1

(57) ABSTRACT

At least one literal value data structure within a literal pool data structure that is capable of being resolved by run-time initialization within a virtual runtime environment is defined by a processor within a memory storage area. A run-time reference to one of the at least one literal value data structure within the literal pool data structure is detected. A determination is made as to whether a literal value at the one of the at least one literal value data structure is resolved and run-time accessible. The literal value at the one of the at least one literal value data structure within the literal pool data structure is resolved during run-time in response to determining that the literal value is not resolved. The resolved literal value is returned.

### BACKGROUND

The present invention relates to dynamic data definition and invalidation. More particularly, the present invention relates to dynamic bootstrap literal processing within a managed runtime environment.

A Java virtual machine (JVM®) may be considered one example of a managed runtime environment. A managed runtime environment may include class libraries that implement an application programming interface (API). Developers interested in developing an application for a given managed runtime environment utilize this API to interface with the application for execution within the managed runtime environment.

### BRIEF SUMMARY

A method includes defining, via a processor within a memory storage area, at least one literal value data structure within a literal pool data structure that is capable of being resolved by run-time initialization within a virtual runtime environment; detecting a run-time reference to one of the at least one literal value data structure within the literal pool data structure; determining whether a literal value at the one of the at least one literal value data structure is resolved and run-time accessible; resolving during run-time the literal value at the one of the at least one literal value data structure within the literal pool data structure in response to determining that the literal value is not resolved; and returning the resolved literal value.

A system includes a memory; and a processor programmed to define within the memory at least one literal value data structure within a literal pool data structure that is capable of being resolved by run-time initialization within a virtual runtime environment; detect a run-time reference to one of the at least one literal value data structure within the literal pool data structure; determine whether a literal value at the one of the at least one literal value data structure is resolved and run-time accessible; resolve during run-time the literal value at the one of the at least one literal value data structure within the literal pool data structure in response to determining that the literal value is not resolved; and return the resolved literal value.

A computer program product includes a computer readable storage medium including computer readable program code, where the computer readable program code when executed on a computer causes the computer to define within a memory storage area at least one literal value data structure within a literal pool data structure that is capable of being resolved by run-time initialization within a virtual runtime environment; detect a run-time reference to one of the at least one literal value data structure within the literal pool data structure; determine whether a literal value at the one of the at least one literal value data structure is resolved and run-time accessible; resolve during run-time the literal value at the one of the at least one literal value data structure within the literal pool data structure in response to determining that the literal value is not resolved; and return the resolved literal value.

### BRIEF DESCRIPTION OF THE SEVERAL VIEWS OF THE DRAWINGS

FIG. 1 is a block diagram of an example of an implementation of a computer system for dynamic bootstrap literal processing within a managed runtime environment according to an embodiment of the present subject matter;

FIG. 2 is a block diagram of an example of an implementation within a memory of a class file format for use in automated dynamic bootstrap literal processing within a managed runtime environment according to an embodiment of the present subject matter;

FIG. 3 is a flow chart of an example of an implementation of a process for automated dynamic bootstrap literal processing within a managed runtime environment according to an embodiment of the present subject matter;

FIG. 4 is a flow chart of an example of an implementation of a process for automated dynamic bootstrap literal processing within a managed runtime environment for bootstrap and access to literals within a literal pool of a multi-threaded environment according to an embodiment of the present subject matter; and

FIG. 5 is a flow chart of an example of an implementation of a process for automated dynamic bootstrap literal processing within a managed runtime environment for invalidation of literals within a literal pool according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides dynamic bootstrap literal processing within a managed runtime environment. The present subject matter provides a new data area termed herein as a “literal pool.” The literal pool allows the literals (e.g., data) to be dynamically created and initialized at first use and invalidated when no longer needed by an application. As such, the literal pool creates a data area for quasi-constant or pseudo-constant values that may be dynamically managed during runtime. The new literal pool also allows the data to be re-initialized (potentially to hold different data), and allows any object subclass to be stored within a literal pool element. The new literal pool also allows for a well-defined lifetime for the items in the literal pool. The lifetime is bounded by a creation phase within a new “load bootstrapped literal” (ldbl) bytecode and an invalidation phase associated with any calls to invalidate the literal as a single invalidation call or a call to invalidate one or more items within the literal pool.

It should be noted that conception of the present subject matter resulted from recognition of certain limitations associated with managed runtime environments. It was recognized that conventional managed runtime environments may provide static constant values, such as a constant pool. Once data in the constant pool has been initialized, it shares the class's lifetime and cannot be invalidated or changed. Similarly, final static fields are provided in some managed runtime environments. Final static fields must be initialized when the class is initialized and can never be changed. The present subject matter improves memory management for literal values by providing for dynamic creation and invalidation of literal values during runtime and in real time within a managed runtime environment, as described above and in more detail below.

It should be noted that the bounded lifetime may allow better optimization by optimizing compilers. For example, the dynamically-created literals are immediately visible to a just-in-time (JIT) compiler. Additionally, processing of the literal pool by interpreters may be improved because the present subject matter does not require a method call to get the pseudo-constant data stored within the literal pool. As such, improved memory allocation and management may be obtained through dynamic bootstrap literal processing within a managed runtime environment, as described herein.

With reference to a Java virtual machine (JVM®), an application developed for execution within the JVM® may be compiled into bytecodes. The bytecodes provide intermediate machine-level style processing instructions for the JVM®. The JVM® executes the bytecodes to perform for the processing for an application as instructed within the bytecodes. Different bytecodes may be created for any runtime environment within which the present subject matter is to be implemented. As such, the present subject matter is directed to the managed runtime environment, and not the particular language that is compiled for execution. The present description utilizes the JVM® as an example platform. However, it is understood that the present subject matter may be applied to any suitable runtime environment with modifications as appropriate for the particular implementation details of the particular runtime environment.

As described above, the present subject matter adds a new bytecode for use within a managed runtime environment that allows for the creation and invalidation of literals within the new literal pool storage area that is accessible to the managed runtime environment. Within the example JVM® platform, the examples below define the new bytecode called “ldbl” (load bootstrapped literal) within the JVM® and Class file format. This bytecode resolves literals when first processed, and returns resolved literals when processed by other threads that may reference the same literal. The literals are entries in the literal pool that are lazily initialized (i.e., when and as used) by a bootstrap java.dyn.MethodHandle. A bootstrapped literal may be any literal that is lazily resolved by a bootstrap method handle (BSM).

As described above, the literal pool represents a new runtime data area that holds bootstrapped literals. Literals are not interned by default and are bootstrapped when and as used. A slot in the literal pool may be in one of two states: a resolved state, meaning the literal has been bootstrapped and may be treated as a constant; or an unresolved state, such that the next ldbl instruction will initiate processing to bootstrap the respective literal. Literals may be invalidated using an invalidation API, and may be re-bootstrapped (potentially to a different data value and/or data type) by a subsequent ldbl instruction.

An example new bytecode for use within the JVM® for loading a bootstrap literal may be represented, for purposes of example, by the following three-byte bytecode format:

ldbl[literalIndex1|literalIndex2]

It is understood that many other possibilities exist for creation of a bytecode for use in association with the present subject matter and all are considered within the scope of the present subject matter. With respect to the example three-byte bytecode format above, the first byte represents the “ldbl” bytecode. The ldbl bytecode may be implemented using any available encoding within the respective managed runtime environment, such as an available binary or hexadecimal encoding (e.g., 0xCB). The second and third bytes form an index into the new “literalPool” storage area.

It should be noted that, for purposes of the present example, the new “literalPool” storage area is a storage area accessible via the index value computed by a combination of the second and third bytes of the “ldbl” instruction. However, this should not be considered limiting as any indexing or identification scheme suitable and supportable for a given implementation is considered within the scope of the present subject matter.

An ldbl instruction may be executed, for example, using an expression such as the following example pseudo code logic expression.

if (literalPool[index] == UNRESOLVED_LITERAL) {

literalRef = literalPool_attributes[index];
if (!literalRef.bsm.isResolved( )) {

literalRef.bsm.resolve( );

}
arguments = getBSMArguments(literalRef);
resolvedLiteral = literalRef.bsm.invokeExact(arguments);
compareAndSwap(literalPool[index], resolvedLiteral,
UNRESOLVED_LITERAL);

}
return literalPool[index];

As can be seen from the example pseudo code above, the example pseudo code checks to determine whether the indexed bootstrap literal has already been resolved during a first execution of the example pseudo code by execution of the conditional statement “if (literalPool[index]==UNRESOLVED_LITERAL).” The value of the “UNRESOLVED_LITERAL” operand may be any suitable binary or hexadecimal value (e.g., binary “0”). If the bootstrap literal is determined to be unresolved, the example pseudo code executes a resolution process to resolve the bootstrap literal at the literal pool index represented by the “index” variable. It the bootstrap literal is determined to have already been resolved or in response to resolving the bootstrap literal, the bootstrap literal at the identified index is returned by the statement “return literalPool[index].”

Regarding resolution of the bootstrap literal, it should be noted that the example pseudo code “resolve( )” function may recursively resolve all dependency information for the bootstrap literal. The example pseudo code then invokes the resolved bootstrap method handle (BSM) to bootstrap the literal. The result is placed into the literal pool at the respective index.

It should be noted that multiple threads may reference a particular bootstrap literal. Where multiple threads reference the same literal slot, there is a potential for a race condition if multiple threads each attempt to bootstrap the same literal. The example pseudo code manages this situation to make certain that all threads return the same result and that only one thread installs the respective literal. The “compareAndSwap” pseudo code represents an atomic operation (e.g., CMPXCHG in the Intel® IA32 instruction set) to ensure that, even if multiple threads attempt to resolve a respective bootstrap literal, only one thread installs the result into the literal pool at the respective index. As such, there is no ambiguity as to how the bootstrap literal is resolved and the bootstrap literal is always resolved using the same code segment in the same way for use by all threads.

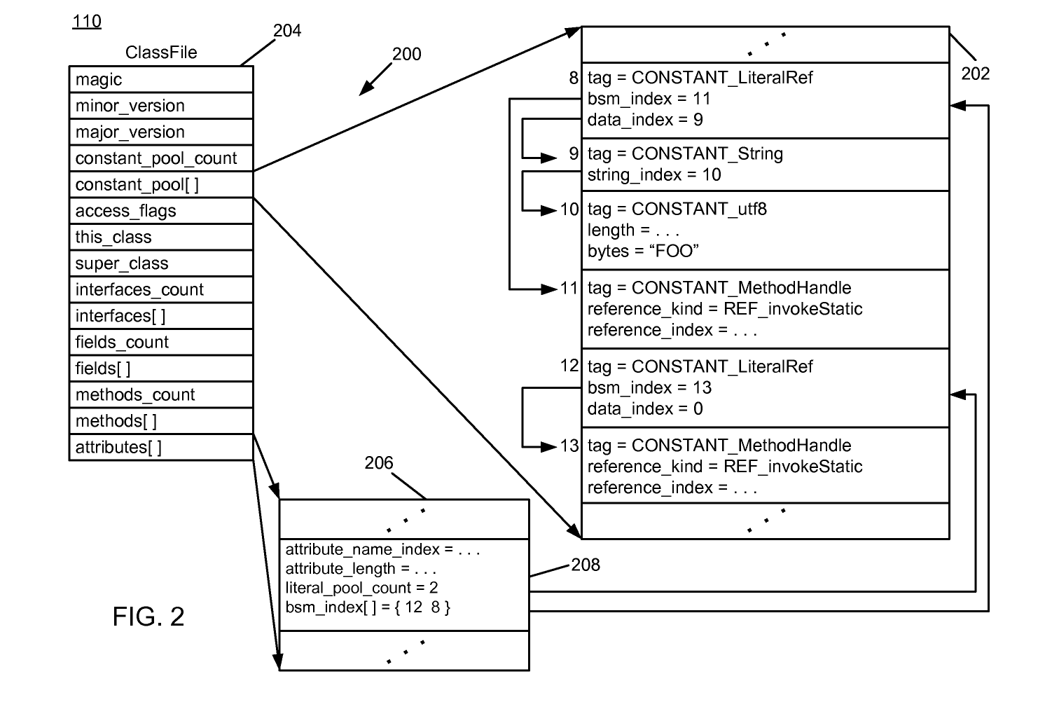

It should additionally be noted that the data “type” of a particular literal slot within the literal pool is an exact match to the return data type of the “CONSTANT_MethodHandle_info” (See FIG. 2 and description below) that bootstraps the particular bootstrap literal. This information will be encoded in the new class file attribute named “LiteralPool.” Two unique ldbl instructions may use the same BSM and different literal pool entries/indexes to ensure that they get “unique” literals. However, two ldbl literals may also refer to the same literal pool entry/index if they desire to share a particular resolved literal.

Within the present example, a new class file attribute named “LiteralPool” specifies the length of the literal pool and the bootstrap information for each literal slot. The attribute description ensures that there is only one possible BSM used to bootstrap the literal for each literal slot in the literal pool. As such, each literal pool slot has only one bootstrap method and all threads use the same bootstrap method at the bytecode level.

The new class file attribute named “LiteralPool” and represented by “LiteralPool_attribute” may have a form represented by the following example pseudo syntax.

LiteralPool_attribute {

u2 attribute_name_index;
u4 attribute_length;
u2 literal_pool_count;
u2 bsm_index[literal_pool_count];

}

It is understood that the type field “u2” and “u4” represent an unsigned two-byte definition and an unsigned four-byte definition, respectively. The “attribute_name_index” represents a valid constant pool entry of type “CONSTANT_Utf8_info” representing the constant string value “LiteralPool.”

The “literal_pool_count” represents the number of entries/slots in the literal pool. The “bsm_index” represents an array of constant pool entries of type “CONSTANT_LiteralRef_info,” where each entry is responsible for bootstrapping the literal slot/entry and providing the type information associated with the literal slot. As such, the “bsm_index[literal_pool_count]” represents an array of indexes to items that indicate which bootstrap method to use for the literal at each index and what data to pass to the respective BSM.

The “CONSTANT_LiteralRef_info” for each slot in the literal pool may be encoded in “LiteralPool_attribute” as described above. The “CONSTANT_LiteralRef_info” may have a form represented by the following pseudo syntax:

CONSTANT_LiteralRef_info {

u1 tag;
u2 bsm_index;
u2 data_index;

}

It is understood that the “tag” field has the value “CONSTANT_LiteralRef” (again, see FIG. 2 and description below). The “bsm_index” represents a hard-coded constant pool index of a “CONSTANT_MethodHandle_info” responsible for bootstrapping the respective bootstrap literal. The “data_index” represents a hard-coded constant pool index of the data to be passed to the respective BSM. If “data_index” is zero (0), the BSM has a signature of “R(Class),” where “R” is the return type of the BSM. If “data_index” refers to a constant pool entry of type “CONSTANT_String,” the BSM has a signature of “R(Class, String),” where “R” is again the return type of the BSM. If “data_index” refers to a constant pool entry of type “CONSTANT_NameAndType,” the BSM has a signature of “R(Class, String name, MethodType type),” where “R” is the return type of the BSM. The “Class” parameter represents the class that contains the literal pool slot being resolved. As such, the value of “data_index” indicates what signature/data to pass to the BSM and the data type of the respective slot in the literal pool may be inferred by the BSM that is called. The result of the BSM is assigned as the value in the respective slot of the literal pool.

Invalidation of bootstrap literals may be performed on either an entire literal pool basis, or on an individual element basis. This functionality provides the “hook” to be able to invalidate an entry, regardless of the type of data stored in the respective literal slot. Invalidation of a particular literal returns the literal to the unresolved state, which releases the data in the slot and breaks the reference to the data so that it may be recovered through garbage collection or another memory recovery mechanism, as appropriate for a given implementation. The literal may be re-resolved the next time it is referenced by another execution of an “ldbl” instruction. Because the invalidation is explicit, the just-in-time (JIT) compiler may, at invalidation, patch any code with assumptions about the value of the literal. As shown within the following two examples, invalidation may be implemented in two static methods on a static helper class named “LiteralPool.”

The following example pseudo syntax shows example processing for invalidation of an entire literal pool to reset all literals in the class to their unresolved state. It should be noted that this operation may be computationally and time intensive.

LiteralPool.invalidateAll (Class toInvalidate) {

VM.getExclusiveAccess( );
for (int i = 0; i <
toInvalidate.literalpool_attributes.literal_pool_count; i++) {

toInvalidate.literalpool[index] = UNRESOLVED_LITERAL;

}
notifyOfLiteralPoolInvalidation(toInvalidate);
VM.releaseExclusiveAccess( );

}

As can be seen from the example pseudo syntax above, a parameter “toInvalidate” is passed into the “invalidateAll” method of the class that owns the literal pool to be reset. Exclusive access to the literal pool is obtained and each entry in the literal pool is set to the unresolved state. The method call to the method “notifyOfLiteralPoolInvalidation(toInvalidate)” notifies any interested parties that the literal pool for this class has been invalidated. Interested parties likely include the JIT compiler that may want to patch code in response to the invalidated literals. Exclusive access to the literal pool is released in response to completion of notification of any interested parties.

The following example pseudo syntax shows example processing for invalidation of an entry of a literal pool slot to an unresolved state.

LiteralPool.invalidateLiteral (Class toInvalidate, int slotIndex) {

VM.getExclusiveAccess( );
toInvalidate.literalpool[index] = UNRESOLVED_LITERAL;
notifyOfLiteralPoolInvalidation(toInvalidate, slotIndex);
VM.releaseExclusiveAccess( );

}

As can be seen from the example pseudo syntax above, a parameter “toInvalidate” is passed into the “invalidateLiteral” method of the class that owns the literal pool with the slot/literal to be reset. A parameter “slotIndex” represents an index of the slot of the literal pool to be reset. Exclusive access to the literal pool is obtained and the entry represented by the slot index parameter is set to the unresolved state. The method call to the method “notifyOfLiteralPoolInvalidation(toInvalidate, slotIndex)” notifies any interested parties that the literal pool for this class has been invalidated. Interested parties likely include the JIT compiler that may want to patch code in response to the invalidated literals. Exclusive access to the literal pool is released in response to completion of notification of any interested parties.

The following example pseudo syntax represents an example of a situation where a JIT compiler may use the well-defined lifecycle of a bootstrap literal provided by the present subject matter to further optimize processing of the bootstrap literal:

String getAString( ) {

Object obj = ldbl #7
if (obj instanceof String) {

return obj;

} else {

return obj.toString( );

}

}

Within the example pseudo syntax above, where the value of “ldbl #7” resolves to a “String” data type, the JIT compiler may optimize the code to “return ldbl #7.” The JIT compiler may also in-line the “getAString( )” method into all of the method's callers, and may actually replace calls to the method with the string object itself. When the “ldbl #7” bootstrap literal is invalidated, the JIT compiler will change that optimized code. The JIT compiler may alternatively update or discard the optimized code for “getAString( )” and may update or discard any object that has in-lined this code. A JIT compiler may chose to discard all code on bootstrap literal invalidation.

The following figures represent additional examples and implementation possibilities associated with the dynamic bootstrap literal processing within a managed runtime environment described herein. It should be noted that the dynamic bootstrap literal processing within a managed runtime environment described herein may be performed in real time to allow prompt creation and invalidation of pseudo-constant data elements. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

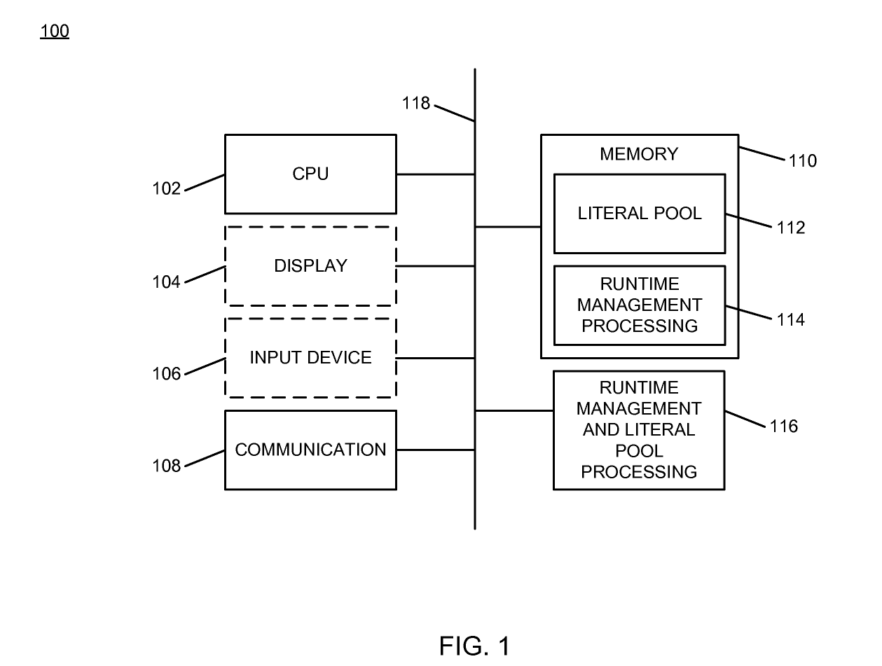

FIG. 1 is a block diagram of an example of an implementation of a computer system 100 for dynamic bootstrap literal processing within a managed runtime environment. As will be described in more detail below in association with FIG. 2 through FIG. 5, the computer system 100 provides automated dynamic bootstrap literal processing within a managed runtime environment. The automated dynamic bootstrap literal processing within a managed runtime environment is based upon the dynamic creation and invalidation of literals for use by one or more threads during runtime.

It should be noted that the computer system 100 may be a portable computing device, either by a user's ability to move the computer system 100 to different locations, or by the computer system 100's association with a portable platform, such as a plane, train, automobile, or other moving vehicle. It should also be noted that the computer system 100 may be any computing device capable of processing information as described above and in more detail below. For example, the computer system 100 may include devices such as a personal computer (e.g., desktop, laptop, etc.) or a handheld device (e.g., cellular telephone, personal digital assistant (PDA), email device, music recording or playback device, watch, etc.), or any other device capable of processing information as described in more detail below.

A central processing unit (CPU) 102 provides computer instruction execution, computation, and other capabilities within the computer system 100. A display 104 provides visual information to a user of the computer system 100 and an input device 106 provides input capabilities for the user.

The display 104 may include any display device, such as a cathode ray tube (CRT), liquid crystal display (LCD), light emitting diode (LED), electronic ink displays, projection, touchscreen, or other display element or panel. The input device 106 may include a computer keyboard, a keypad, a mouse, a pen, a joystick, or any other type of input device by which the user may interact with and respond to information on the display 104.

It should be noted that the display 104 and the input device 106 are illustrated with a dashed-line representation within FIG. 1 to indicate that they may be optional components for the computer system 100 for certain implementations. Accordingly, the computer system 100 may operate as a completely automated embedded device without direct user configurability or feedback. However, the computer system 100 may also provide user feedback and configurability via the display 104 and the input device 106, respectively.

A communication module 108 provides interconnection capabilities that allow the computer system 100 to communicate with other modules, such as a server or other device via one or more wired or wireless network connections (not shown), to access within, retrieve from and/or provide information to such other device(s). The communication module 108 may include any electrical, protocol, and protocol conversion capabilities useable to provide the interconnection capabilities. Though the communication module 108 is illustrated as a component-level module for ease of illustration and description purposes, it should be noted that the communication module 108 may include any hardware, programmed processor(s), and memory used to carry out the functions of the communication module 108 as described above and in more detail below. For example, the communication module 108 may include additional controller circuitry in the form of application specific integrated circuits (ASICs), processors, antennas, and/or discrete integrated circuits and components for performing communication and electrical control activities associated with the communication module 108. Additionally, the communication module 108 may include interrupt-level, stack-level, and application-level modules as appropriate. Furthermore, the communication module 108 may include any memory components used for storage, execution, and data processing for performing processing activities associated with the communication module 108. The communication module 108 may also form a portion of other circuitry described without departure from the scope of the present subject matter.

A memory 110 includes a literal pool storage area 112 that stores one or more literal pools, as described above, for use by the computer system 100. A runtime management processing area 114 provides execution and other memory allocation space for the computer system 100. For example, the runtime management processing area 114 may provide both storage space for class file and attributes, as described above.

It is understood that the memory 110 may include any combination of volatile and non-volatile memory suitable for the intended purpose, distributed or localized as appropriate, and may include other memory segments not illustrated within the present example for ease of illustration purposes. For example, the memory 110 may include a code storage area, an operating system storage area, a code execution area, and a data area without departure from the scope of the present subject matter.

A runtime management and literal pool processing module 116 is also illustrated. The runtime management and literal pool processing module 116 provides runtime processing and literal pool processing for the computer system 100, as described above and in more detail below. The runtime management and literal pool processing module 116 implements the automated dynamic bootstrap literal processing within a managed runtime environment of the computer system 100.

Though the runtime management and literal pool processing module 116 is illustrated as a component-level module for ease of illustration and description purposes, it should be noted that the runtime management and literal pool processing module 116 may include any hardware, programmed processor(s), and memory used to carry out the functions of this module as described above and in more detail below. For example, the runtime management and literal pool processing module 116 may include additional controller circuitry in the form of application specific integrated circuits (ASICs), processors, and/or discrete integrated circuits and components for performing communication and electrical control activities associated with the respective devices. Additionally, the runtime management and literal pool processing module 116 may include interrupt-level, stack-level, and application-level modules as appropriate. Furthermore, the runtime management and literal pool processing module 116 may include any memory components used for storage, execution, and data processing for performing processing activities associated with the module.

It should also be noted that the runtime management and literal pool processing module 116 may form a portion of other circuitry described without departure from the scope of the present subject matter. Further, the runtime management and literal pool processing module 116 may alternatively be implemented as an application stored within the memory 110. In such an implementation, the runtime management and literal pool processing module 116 may include instructions executed by the CPU 102 for performing the functionality described herein. The CPU 102 may execute these instructions to provide the processing capabilities described above and in more detail below for the computer system 100. The runtime management and literal pool processing module 116 may form a portion of an interrupt service routine (ISR), a portion of an operating system, a portion of a browser application, or a portion of a separate application without departure from the scope of the present subject matter.

The CPU 102, the display 104, the input device 106, the communication module 108, the memory 110, and the runtime management and literal pool processing module 116 are interconnected via an interconnection 118. The interconnection 118 may include a system bus, a network, or any other interconnection capable of providing the respective components with suitable interconnection for the respective purpose.

While the computer system 100 is illustrated with and has certain components described, other modules and components may be associated with the computer system 100 without departure from the scope of the present subject matter. Additionally, it should be noted that, while the computer system 100 is described as a single device for ease of illustration purposes, the components within the computer system 100 may be co-located or distributed and interconnected via a network without departure from the scope of the present subject matter. For a distributed arrangement, the display 104 and the input device 106 may be located at a point of sale device, kiosk, or other location, while the CPU 102 and memory 110 may be located at a local or remote server. Many other possible arrangements for components of the computer system 100 are possible and all are considered within the scope of the present subject matter. Accordingly, the computer system 100 may take many forms and may be associated with many platforms.

FIG. 2 is a block diagram of an example of an implementation within the memory 110 of a class file format 200 for use in automated dynamic bootstrap literal processing within a managed runtime environment. To avoid crowding within the drawing figure, a box is not drawn around particular elements of FIG. 2. However, it is understood that all elements represented within FIG. 2 may be generated, stored, and manipulated within the memory 110 of the computer system 100 shown and described in association with FIG. 1, and represented within FIG. 2 with the underlined reference designator “110.” The class file format 200 includes a constant pool 202 within a class file section 204 and includes an attributes section 206 within the class file section 204. The attributes section 206 defines a literal pool 208, as described above and in more detail below.

It should be noted that any of sections illustrated within the class file section 204 that include square brackets (e.g., “[ ]”) at the end of the respective identifiers represent arrays (e.g., “constant_pool[ ],” “attributes[ ],” etc.). Additionally, certain elements are illustrated within breakout sections illustrated for arrays represented as the constant pool 202 and the attributes section 206. However, it is understood that certain other elements of the respective arrays are omitted from the drawing figure due to space limitations (as represented by the respective leading and ending angled ellipsis dots within the drawing figures), though it is also noted that other elements are not required and that the respective elements may be located at any location within the respective arrays if other elements are present. Further, for purposes of the present example, it should be noted that the constant pool 202, the class file section 204, and the attributes section 206 may be stored within the runtime management processing area 114, while the literal pool 208 defined by the attributes section 206 may be stored within the literal pool storage area 112.

The class file (ClassFile) 204 defines a “constant_pool_count” that identifies the number of constant pool entries associated with the class file 204. The class file 204 additionally defines a constant pool that is instantiated/defined as the constant pool (CONSTANT_POOL) 202 within a “constant_pool[ ]” area. It is understood that the size and dimensions of the constant pool 202 may be defined according to the particular implementation. As introduced above, the attributes section 206 is used to define various class file extensions. The attributes section 206 may include zero or one attributes that define a literal pool represented within FIG. 2 by the literal pool 208. As described above and as shown within FIG. 2, the literal pool 208 defines an attribute name index, an attribute length, a literal pool count, and an array of BSM indexes, as described above. For purposes of the present example, it is noted that the literal pool 208 is defined to include two (2) slots (literal_pool_count=2). For purposes of the present description, the slots each represent a literal value data structure within the literal pool data structure at which literal values may be resolved during run-time, as described above and in more detail below. Other variations are available as appropriate for a given implementation.

Regarding the literal pool 208, the literal pool 208 defines zero or more entries/slots (two within the present example) as indexes into the constant pool 202. The indexes refer to constant pool 202 entries of type “CONSTANT_LiteralRef.” CONSTANT_LiteralRef is a constant defined by the class file 204. It has a unique integer value (e.g., 15). Each CONSTANT_LiteralRef constant pool entry consists of a tag identifying its type (CONSTANT_LiteralRef), a bsm_index referring to a CONSTANT_MethodHandle constant pool entry, and a data_index which may be zero or may refer to a constant pool entry of type CONSTANT_String or CONSTANT_NameAndType.

Within the present example, the first index (12) of the bsm_index[ ] field within the literal pool 208 refers to the constant pool 202 entry at index twelve (12) of type CONSTANT_LiteralRef (note that this index is shown via an arrow to the right of the constant pool 202) and the second index refers to the constant pool 202 entry at index eight (8) of type CONSTANT_LiteralRef (note also that this index is shown via an arrow to the right of the constant pool 202). The constant pool 202 entry at index twelve (12) has a data_index of zero (0). The constant pool 202 at index eight (8) has a data_index of nine (9), which refers to the constant pool 202 entry at index nine (9) of type CONSTANT_String (note also that this index is shown via an arrow to the left of the constant pool 202). The remaining indexing within FIG. 2 is also shown with additional arrows to the left of the constant pool 202.

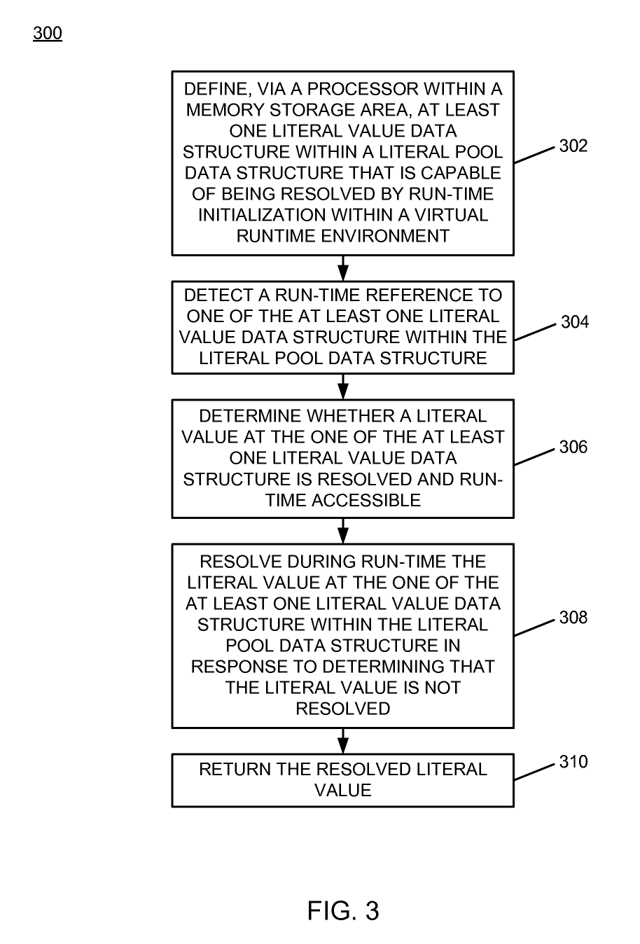

FIG. 3 through FIG. 5 below describe example processes that may be executed by devices, such as the computer system 100, to perform the automated dynamic bootstrap literal processing within a managed runtime environment associated with the present subject matter. Many other variations on the example processes are possible and all are considered within the scope of the present subject matter. The example processes may be performed by modules, such as the runtime management and literal pool processing module 116 and/or executed by the CPU 102, associated with such devices. It should be noted that time out procedures and other error control procedures are not illustrated within the example processes described below for ease of illustration purposes. However, it is understood that all such procedures are considered to be within the scope of the present subject matter.

FIG. 3 is a flow chart of an example of an implementation of a process 300 for automated dynamic bootstrap literal processing within a managed runtime environment. At block 302, the process 300 defines, via a processor within a memory storage area, at least one literal value data structure within a literal pool data structure that is capable of being resolved by run-time initialization within a virtual runtime environment. At block 304, the process 300 detects a run-time reference to one of the at least one literal value data structure within the literal pool data structure. At block 306, the process 300 determines whether a literal value at the one of the at least one literal value data structure is resolved and run-time accessible. At block 308, the process 300 resolves during run-time the literal value at the one of the at least one literal value data structure within the literal pool data structure in response to determining that the literal value is not resolved. At block 310, the process 300 returns the resolved literal value.

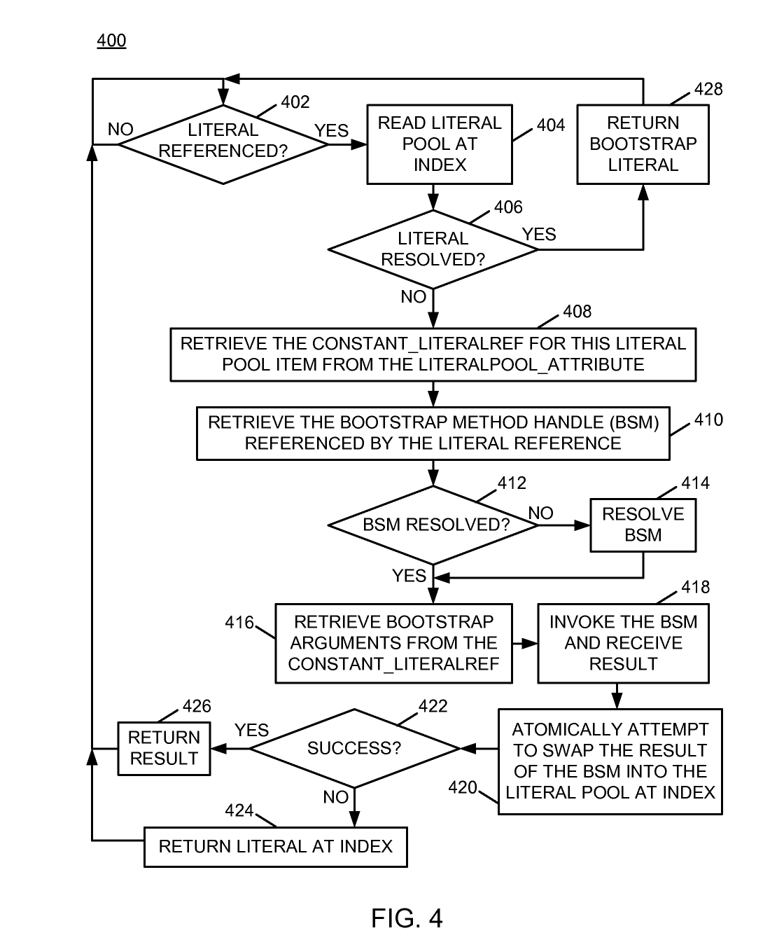

FIG. 4 is a flow chart of an example of an implementation of a process 400 for automated dynamic bootstrap literal processing within a managed runtime environment for bootstrap and access to literals within a literal pool of a multi-threaded environment. At decision point 402, the process 400 makes a determination as to whether a literal (e.g., a slot/index) within a literal pool has been referenced for bootstrapping. As described above, a bootstrap literal may be referenced for bootstrapping using an “ldbl” instruction or other instruction as appropriate for a given implementation. In response to determining that a literal within a literal pool has been referenced, the process 400 reads the literal pool at the referenced literal pool slot/index at block 404. At decision point 406, the process 400 makes a determination as to whether the reference literal is already resolved.

As described above, a first reference to a literal within a literal pool will result in an unresolved literal determination and resolution of the referenced literal. Additionally, multiple threads may execute and reference the same literal. Accordingly, as described above and in more detail below, a determination may be made at the initial reference that a literal is unresolved by more than one thread and each thread may attempt to bootstrap the referenced literal. This may result in a race condition that is managed as described in more detail below.

As such, in response to determining that the referenced literal is not resolved, the process 400 retrieves the literal pool reference (e.g., CONSTANT_LiteralRef) for the bootstrap method handle (BSM) that is responsible for bootstrapping the literal slot from the literal pool attribute (LiteralPool_attribute) at block 408.

At block 410, the process 400 retrieves the bootstrap method handle (BSM) referenced by the literal reference. At decision point 412, the process 400 makes a determination as to whether the bootstrap method referenced by the bootstrap method handle has been resolved. In response to determining that the bootstrap method has not been resolved, the process 400 resolves the bootstrap method at block 414. In response to either resolving the bootstrap method at block 414 or in response to determining that the bootstrap method has been resolved at decision point 412, the process 400 retrieves the bootstrap arguments (e.g., getBSMArguments) using the literal reference at block 416. At block 418, the process 400 invokes the bootstrap loader method with the retrieved bootstrap arguments and receives a resulting resolved literal from the BSM. Invoking the bootstrap loader method resolves during run-time the literal value at the referenced literal of the referenced literal value data structure within the literal pool data structure. Resolution of the literal value may include executing a user-defined function defined by a literal pool attribute to compute the resolved literal value. Further, resolution of the literal value may include inferring a data type of the resolved literal value from a signature of the user-defined function defined by the literal pool attribute, as described above with respect to return types of bootstrap method handles (BSMs).

At block 420, the process 400 attempts to atomically swap the resulting resolved literal received in response to invocation of the bootstrap method into the literal pool at the referenced index/slot. This processing will determine whether the literal is still unresolved within the literal pool slot. As described above, in a multi-threaded environment, multiple threads may attempt to bootstrap the same literal concurrently. As such, this processing manages a potential race condition between the multiple threads to ensure that the referenced bootstrap literal is resolved once.

At decision point 422, the process 400 makes a determination as to whether the attempt to swap the resolved bootstrap literal into the literal pool slot was successful. In response to determining that the attempt to swap the resolved bootstrap literal into the literal pool slot was not successful, the process 400 returns the literal at the referenced index that was previously bootstrapped by another thread at block 424. In response to determining that the attempt to swap the resolved bootstrap literal into the literal pool slot was successful, the process 400 returns the resulting resolved bootstrap literal resolved by the current thread at block 426. In response to returning the respective literal at block 424 or block 426, the process 400 returns to decision point 402 and iterates as described above.

Returning to the description of decision point 406, for any subsequent reference to a literal after an initial reference and prior to invalidation of a bootstrap literal, the process 400 determines at decision point 406 that the referenced literal is resolved and returns the referenced bootstrap literal at block 428. The process 400 returns to decision point 402 and iterates as described above.

As such, the process 400 operates to process bootstrapping of literals within a bootstrap literal pool and manages race conditions between multiple threads to bootstrap the same literal slot. In response to determining that the literal is not resolved, the process 400 attempts to resolve the referenced literal, and returns either the literal as resolved concurrently by another thread ahead of the current thread, or returns the literal as resolved by the current thread. The process subsequently returns a previously bootstrapped literal in response to determining that the literal is already resolved prior to invalidation of the respective bootstrap literal.

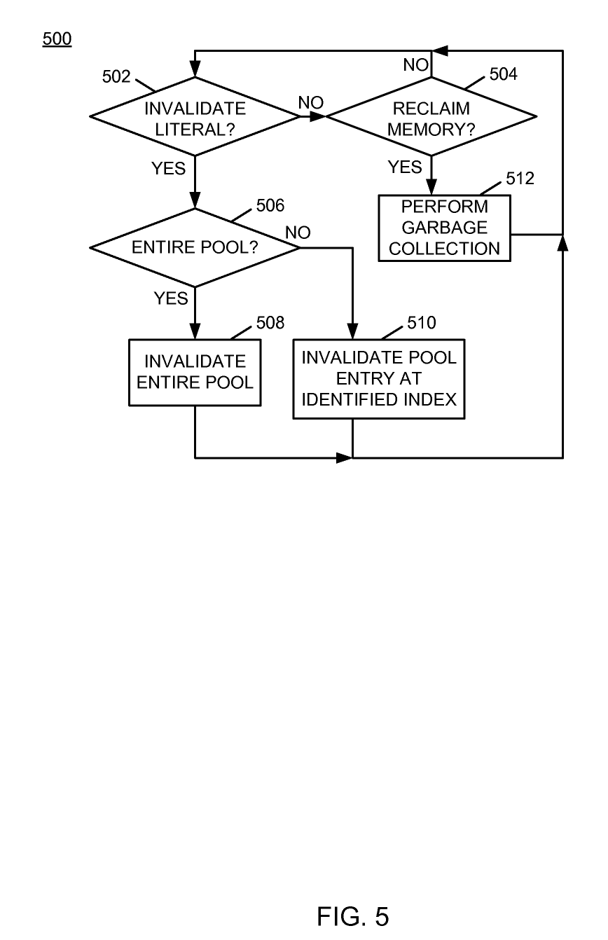

FIG. 5 is a flow chart of an example of an implementation of a process 500 for automated dynamic bootstrap literal processing within a managed runtime environment for invalidation of literals within a literal pool. At decision point 502, the process 500 begins higher-level processing and makes a determination as to whether a request has been detected to invalidate at least one literal within a literal pool. A request to invalidate a literal may be detected, for example, in response to invocation of a routine to invalidate either a single referenced literal or an entire literal pool, as described above. In response to determining that a request to invalidate at least one literal has not been detected, the process 500 makes a determination at decision point 504 as to whether to reclaim memory for released resources, such as literals from a literal pool. In response to determining not to reclaim memory at decision point 504, the process 500 returns to decision point 502 and iterates as described above.

In response to determining at decision point 502 that that a request to invalidate at least one literal has been detected, the process 500 makes a determination at decision point 506 as to whether the request is a request to invalidate an entire literal pool. In response to determining that the request is a request to invalidate an entire literal pool, the process 500 invalidates each slot within the referenced literal pool at block 508. In response to determining that the request is a request to invalidate a single referenced literal within a literal pool, the process 500 invalidates the referenced literal within the referenced literal pool at block 510. In response to performing the respective invalidation at block 508 or at block 510, the process 500 returns to decision point 502 and iterates as described above.

Returning to the description of decision point 504, in response to determining to reclaim memory for released resources, such as literals from a literal pool, the process 500 performs garbage collection at block 512. In response to completion of reclaiming released resources by garbage collection at block 512, the process 500 returns to decision point 502 and iterates as described above.

As such, the process 500 manages requests to invalidate individual slots within a literal pool or an entire literal pool and performs garbage collection for any released resources that are available for reclamation. As such, the process 400 of FIG. 4 in conjunction with the process 500 of FIG. 5 provide for a managed well-defined lifetime for the items within a literal pool, and for release and retrieval of memory resources associated with a literal pool. The lifetime of a literal is bounded by a creation phase, such as that described above in association with the process 400, and an invalidation phase managed by the process 500. As also described above, invalidation of a particular literal returns the literal to an unresolved state, which releases the data in the slot and breaks the reference to the data so that it may be recovered through garbage collection or another memory recovery mechanism, as appropriate for a given implementation. The literal may be re-resolved the next time it is referenced by another execution of an “ldbl” instruction. The process 400 and the process 500 may be combined into a single process without departure from the scope of the present subject matter.

As described above in association with FIG. 1 through FIG. 5, the example systems and processes provide automated dynamic bootstrap literal processing within a managed runtime environment. Many other variations and additional activities associated with automated dynamic bootstrap literal processing within a managed runtime environment are possible and all are considered within the scope of the present subject matter.

Those skilled in the art will recognize, upon consideration of the above teachings, that certain of the above examples are based upon use of a programmed processor, such as the CPU 102. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
defining, via a processor within a memory storage area, at least one literal value data structure within a literal pool data structure that is capable of being resolved by run-time initialization within a virtual runtime environment;
detecting a run-time reference to one of the at least one literal value data structure within the literal pool data structure;
determining whether a literal value at the one of the at least one literal value data structure is resolved and run-time accessible;
resolving during run-time the literal value at the one of the at least one literal value data structure within the literal pool data structure in response to determining that the literal value is not resolved; and
returning the resolved literal value.

2. The method of claim 1, further comprising unresolving, via the processor, the literal value at the one of the at least one literal value data structure of the literal pool data structure in response to a code instruction to unresolve the literal value.

3. The method of claim 1, where defining, via the processor within the memory storage area, the at least one literal value data structure within the literal pool data structure that is capable of being resolved by run-time initialization within the virtual runtime environment comprises defining a single bootstrap loader method (BSM) for each literal value data structure within the literal pool data structure, where each of a plurality of threads executed by the processor invoke the same single BSM to bootstrap the literal value.

4. The method of claim 1, where resolving during run-time the literal value at the one of the at least one literal value data structure within the literal pool data structure in response to determining that the literal value is not resolved comprises executing a user-defined function defined by a literal pool attribute to compute the resolved literal value.

5. The method of claim 4, further comprising inferring a data type of the resolved literal value from a signature of the user-defined function defined by the literal pool attribute.

6. The method of claim 1, where resolving during run-time the literal value at the one of the at least one literal value data structure within the literal pool data structure in response to determining that the literal value is not resolved comprises:
determining whether any other thread is contemporaneously attempting to resolve the literal value; and
allowing only one thread to resolve the literal value.

7. The method of claim 1, where a data type of each of the at least one literal value data structure within the literal pool data structure is defined by a return type of a bootstrap loader method (BSM) that bootstraps the respective literal value at each of the at least one literal value data structure within the literal pool data structure to allow different data types for different ones of the at least one literal value data structure.

8. A system, comprising:
a memory; and
a processor programmed to:
define within the memory at least one literal value data structure within a literal pool data structure that is capable of being resolved by run-time initialization within a virtual runtime environment;
detect a run-time reference to one of the at least one literal value data structure within the literal pool data structure;
determine whether a literal value at the one of the at least one literal value data structure is resolved and run-time accessible;
resolve during run-time the literal value at the one of the at least one literal value data structure within the literal pool data structure in response to determining that the literal value is not resolved; and
return the resolved literal value.

9. The system of claim 8, where the processor is further programmed to unresolve the literal value at the one of the at least one literal value data structure of the literal pool data structure in response to a code instruction to unresolve the literal value.

10. The system of claim 8, where, in being programmed to define within the memory the at least one literal value data structure within the literal pool data structure that is capable of being resolved by run-time initialization within the virtual runtime environment, the processor is programmed to define a single bootstrap loader method (BSM) for each literal value data structure within of the literal pool data structure, where each of a plurality of threads executed by the processor invoke the same single BSM to bootstrap the literal value.

11. The system of claim 8, where, in being programmed to resolve during run-time the literal value at the one of the at least one literal value data structure within the literal pool data structure in response to determining that the literal value is not resolved, the processor is programmed to execute a user-defined function defined by a literal pool attribute to compute the resolved literal value, and where the processor is further programmed to infer a data type of the resolved literal value from a signature of the user-defined function defined by the literal pool attribute.

12. The system of claim 8, where, in being programmed to resolve during run-time the literal value at the one of the at least one literal value data structure within the literal pool data structure in response to determining that the literal value is not resolved, the processor is programmed to:
determine whether any other thread is contemporaneously attempting to resolve the literal value; and
allow only one thread to resolve the literal value.

13. The system of claim 8, where a data type of each of the at least one literal value data structure within the literal pool data structure is defined by a return type of a bootstrap loader method (BSM) that bootstraps the respective literal value at each of the at least one literal value data structure within the literal pool data structure to allow different data types for different ones of the at least one literal value data structure.

14. A computer program product comprising a computer readable storage medium including computer readable program code, where the computer readable program code when executed on a computer causes the computer to:
define within a memory storage area at least one literal value data structure within a literal pool data structure that is capable of being resolved by run-time initialization within a virtual runtime environment;
detect a run-time reference to one of the at least one literal value data structure within the literal pool data structure;
determine whether a literal value at the one of the at least one literal value data structure is resolved and run-time accessible;
resolve during run-time the literal value at the one of the at least one literal value data structure within the literal pool data structure in response to determining that the literal value is not resolved; and
return the resolved literal value.

15. The computer program product of claim 14, where the computer readable program code when executed on the computer further causes the computer to unresolve the literal value at the one of the at least one literal value data structure of the literal pool data structure in response to a code instruction to unresolve the literal value.

16. The computer program product of claim 14, where in causing the computer to define within the memory storage area the at least one literal value data structure within the literal pool data structure that is capable of being resolved by run-time initialization within the virtual runtime environment, the computer readable program code when executed on the computer causes the computer to define a single bootstrap loader method (BSM) for each literal value data structure within of the literal pool data structure, where each of a plurality of threads executed by the computer invoke the same single BSM to bootstrap the literal value.

17. The computer program product of claim 14, where in causing the computer to resolve during run-time the literal value at the one of the at least one literal value data structure within the literal pool data structure in response to determining that the literal value is not resolved, the computer readable program code when executed on the computer causes the computer to execute a user-defined function defined by a literal pool attribute to compute the resolved literal value.

18. The computer program product of claim 17, where the computer readable program code when executed on the computer further causes the computer to infer a data type of the resolved literal value from a signature of the user-defined function defined by the literal pool attribute

19. The computer program product of claim 14, where in causing the computer to resolve during run-time the literal value at the one of the at least one literal value data structure within the literal pool data structure in response to determining that the literal value is not resolved, the computer readable program code when executed on the computer causes the computer to:
determine whether any other thread is contemporaneously attempting to resolve the literal value; and
allow only one thread to resolve the literal value.

20. The computer program product of claim 14, where a data type of each of the at least one literal value data structure within the literal pool data structure is defined by a return type of a bootstrap loader method (BSM) that bootstraps the respective literal value at each of the at least one literal value data structure within the literal pool data structure to allow different data types for different ones of the at least one literal value data structure.
